(19) United States
(12) Patent Application Publication
(10) Pub. No.: US 2025/0037435 A1
(43) Pub. Date: Jan. 30, 2025

(54) Microscopy system and method for generating registered microscope images

(71) Applicant: Carl Zeiss Microscopy GmbH, Jena (DE)

(72) Inventors: Manuel Amthor, Jena (DE); Daniel Haase, Zoellnitz (DE)

(21) Appl. No.: 18/782,142

(22) Filed: Jul. 24, 2024

(30) Foreign Application Priority Data
Jul. 26, 2023 (DE) 10 2023 119 848.3

(51) Int. Cl. G06V 10/774; G06T 11/00; G06V 10/40; G06V 20/69; G06V 20/70

(52) U.S. Cl. CPC G06V 10/774; G06T 11/00; G06V 10/40; G06V 20/69; G06V 20/70

(57) ABSTRACT

A computer-implemented method for generating pairs of registered microscope images includes training a generative model to create generated microscope images from input feature vectors comprising feature variables. The training uses image data sets which respectively contain microscope images of microscopic objects but which differ in an imaging/image property. It is identified which of the feature variables are object feature variables, which define at least object positions of microscopic objects in generated microscope images, and which of the feature variables are imaging-property feature variables, which determine a depiction of the microscopic objects in generated microscope images depending on the imaging/image property. At least a pair of generated microscope images is created from feature vectors with corresponding object feature variables and differing imaging-property feature variables, so that the generated microscope images show objects with corresponding object positions, but with a difference in the imaging/image property.

### REFERENCE TO RELATED APPLICATIONS

The current application claims the benefit of German Patent Application No. 10 2023 119 848.3, filed on Jul. 26, 2023, which is hereby incorporated by reference.

### FIELD OF THE DISCLOSURE

The present disclosure relates to a microscopy system and a method for generating registered microscope images.

### BACKGROUND OF THE DISCLOSURE

Image processing based on machine-learned models is playing an increasingly important role in modern microscopes. Example applications of machine-learned models include sample localization and navigation, an automatic counting of microscopic objects in captured images, automation of workflows, detection of defective measurement situations, resolution enhancement, deconvolution of captured images, virtual staining, artefact removal, segmentation of structures of interest, image sharpening, and the classification of depicted structures or image properties.

In addition to the design of the models and their optimization, the data basis of the training of the models is pivotal. Building up a sufficient data basis frequently constitutes the bottleneck in the development of high-quality models. In particular in the case of segmentation mappings or image-to-image mappings, practical limits are quickly reached in the provision of training data. In particular, when both the inputs and outputs of a machine learning model are images or figurative, image data often has to be provided manually by an expert. For example, segmentation masks are often created manually or partly manually for a training. The investment in terms of time, resources and work is correspondingly high.

Moreover, an essential requirement for training images in such scenarios is that corresponding images (i.e. associated input and output images) are co-registered. This means that a sample point has the same coordinates in both images or, in other words, both images relate to a common coordinate system. The requirement for image pairs to be registered complicates the generation of training data considerably.

The creation of training data is complex, for example, in the case of a:
segmentation of sample areas in a microscope image: it is necessary here for an expert to manually annotate which areas are to be considered part of a sample in a laborious process.
virtual staining: it is necessary here to capture image pairs, the respective images of which show exactly the same sample positions, but with different contrast types. If a sample is chemically stained, the original contrast is subsequently irretrievable.

In order to avoid the measurement work involved in creating registered image pairs, simulations based on a physical model are in principle possible. Such models are, however, usually limited in terms of what they can express. This often results in unrealistic representations.

Some image processing is possible without registered training data using CycleGANs (GAN: generative adversarial networks), as described in:
ZHU, Jun-Yan, et al: “Unpaired image-to-image translation using cycle-consistent adversarial networks”; Proceedings of the IEEE international conference on computer vision. 2017. pp. 2223-2232.

CycleGANs use, inter alia, two generators and two training data sets. An image of the first training data set is input into the first generator, which uses it to calculate an output image that is ideally indistinguishable for a discriminator from the images of the second training data set. The output image is also input into the second generator, which uses it to calculate an image that ideally corresponds to the original image (cycle consistency). Similarly, the second generator is used to calculate, from an image of the second training data set, an output image which is indistinguishable from images of the first data set and from which the first generator can calculate an image that ideally corresponds to the original image. A registration of the images of the two training data sets is not necessary. Due to the cycle consistency, positions of depicted objects in the output image of a generator should largely match the positions of corresponding objects in the input image. There is no explicit generation of registered image pairs in this approach, however. It is not guaranteed that learned correspondences between structures correspond to the actual relationships. It can thus occur that the model is based on structural correlations in the training data set that coincidentally result in a minimization of the loss function of the CycleGAN. As a result, positions of objects in input and output images do not necessarily match. The “implicit” (and unreliable) registration with CycleGANs also precludes an interpretation or evaluation of positional relationships, as image pairs are not considered or evaluated in the training with regard to a positional fidelity.

The requirement that image pairs are registered for training data of machine learning models thus continues to represent a major hurdle, so that the provision of suitable training data continues to involve considerable expenditure in terms of time and labor. A large investment of manual effort is necessary to provide registered image pairs that differ in a desired property in order to be usable as training data for image processing models. The invention is intended to make data sets without a registration exploitable as training data by using such data sets to create registered image pairs.

As background information, reference is made to:
XUN Huang, “Arbitrary Style Transfer in Real-time with Adaptive Instance Normalisation”, arXiv:1703.06868v2 [cs.CV] 30 Jul. 2017
   where it is described how to represent the content of an image in the style of a second image.

The fundamentals of generative adversarial networks (GAN) are described in:
GOODFELLOW, Ian J., et al. “Generative adversarial networks”, arXiv:1406.2661v1 [stat.ML] 10 Jun. 2014

Reference is also made to the networks known as StyleGAN and StyleGAN2, as described in:
KARRAS, Tero, et al. “A style-based generator architecture for generative adversarial networks”, Proceedings of the IEEE/CVF Conference on Computer Vision and Pattern Recognition, 2019. pages 4401-4410.
KARRAS, Tero, et al. “Analysing and Improving the Image Quality of StyleGAN” arXiv:1912.04958v2 [cs.CV] 23 Mar. 2020; and in: Proceedings of the IEEE/CVF Conference on Computer Vision and Pattern Recognition, 2020, pages 8110-8119.

A design known as StyleGAN3 or “Alias-Free GAN” is described in:
KARRAS, Tero, et al: “Alias-Free Generative Adversarial Networks”, arXiv:2106.12423v4 [cs.CV] 18 Oct. 2021.

An input into a generator, for example in the case of an Alias-Free GAN, can be a so-called Fourier feature. In this case, the entered values are used as coefficients of a Fourier series, the outputs of which are processed in the generator. This allows higher-frequency image components to be better encoded in the input vector. Fourier features are described, for example, in:
TANCIK, Matthew, et al: “Fourier Features Let Networks Learn High Frequency Functions in Low Dimensional Domains”, arXiv:2006.10739v1 [cs.CV] 18 Jun. 2020.

### SUMMARY OF THE DISCLOSURE

It can be considered an object of the invention to indicate a method and a microscopy system for generating co-registered image pairs from unregistered image data sets with minimal manual effort.

This object is achieved by the microscopy system and the methods with the features according to the independent patent claims.

The invention provides a computer-implemented method for generating pairs of registered microscope images, wherein a generative model is trained to create generated microscope images from input feature vectors. The feature vectors comprise a plurality of feature variables. Training is carried out with at least two image data sets, which respectively contain microscope images of microscopic objects but which differ in an imaging/image property. It is identified which of the feature variables are object feature variables, which define at least object positions of microscopic objects in generated microscope images. It is also identified which of the feature variables are imaging-property feature variables, which determine a depiction of the microscopic objects in generated microscope images as a function of the imaging/image property and which do not influence the object positions in generated microscope images. By means of the generative model, at least one pair of generated microscope images is created from feature vectors which correspond in the object feature variables and differ in the imaging-property feature variables. The generated microscope images of a pair thus show microscopic objects with corresponding object positions, but with a difference in the imaging/image property.

The invention also provides a computer-implemented method for generating pairs of registered microscope images, wherein a generative model is trained to create generated microscope images from input feature vectors. The feature vectors comprise a plurality of feature variables. Training is carried out with at least two image data sets, which respectively contain microscope images of microscopic objects but which differ in an imaging/image property. It is identified which of the feature variables are object feature variables, which define at least object positions of microscopic objects in generated microscope images. It is also identified which of the feature variables are imaging-property feature variables, which determine a depiction of the microscopic objects in generated microscope images as a function of the imaging/image property and which do not influence the object positions in generated microscope images. At least one pair of registered microscope images is subsequently created, wherein each pair comprises a provided microscope image and a microscope image generated by the generative model. To this end, each provided microscope image is back-projected into a feature space in order to identify values of the object feature variables for the provided microscope image. An associated generated microscope image which is registered in relation to the provided microscope image and which differs from the provided microscope image in an imaging/image property is created by inputting a feature vector which has the values of the object feature variables identified by back-projection, but different values of the imaging-property feature variables, into the generative model.

A microscopy system according to the invention comprises a microscope for imaging and a computing device configured to carry out one of the computer-implemented methods according to the invention.

A computer program according to the invention comprises instructions which, when the program is executed by a computer, cause the computer to carry out one of the methods according to the invention.

The invention allows new images to be generated from a collection of unrelated microscope images of, for example, biological cells, wherein the new images comprise the typical properties and features of the image data collection. In contrast to conventional methods, however, the invention provides co-registered images. The image collection which constitutes the training data can contain two or more different image data sets, for example an image data set of phase contrast images of microscopic objects and an image data set of fluorescence images of microscopic objects. These image data sets are not co-registered or at least comprise unregistered images. By means of the invention, it is possible to create new images which correspond in type to the original image data sets (e.g. to phase contrast images and fluorescence images) but are co-registered. The generated, registered image pairs can in particular serve as training data for other machine-learned models.

In contrast, the CycleGANs described in the introduction are not able to create a training data set that contains explicitly registered image pairs. It is thus not possible with CycleGANs to create image data for an established procedure/algorithm that requires registered image data for its training such as, e.g., standard models for virtual staining, deconvolution or descattering. By contrast, the invention ensures an image registration by explicitly defining equal, i.e., matching position values, which also enables a qualitative or quantitative evaluation of created pairs of registered microscope images.

### Optional Embodiments

Variants of the microscopy system according to the invention and of the methods according to the invention are the object of the dependent claims and are explained in the following description.

### Imaging/Image Property

The generative model is trained so as to be able to create generated microscope images that are to correspond in type to provided training images. It should thus not be possible to distinguish whether an image is a generated microscope image or an image of the training images.

The training images for the generative model comprise at least two image data sets, which do not have to be provided separately, but can form a common training data set. The image data sets respectively contain microscope images of microscopic objects, which can represent the same type of object, e.g. biological cells or cell parts, electronic components or material/rock samples. The image data sets differ in at least one imaging/image property and are not registered, i.e. it is not necessary for them to be registered. More specifically, although the training images can include some registered image pairs, a registration is not required or utilized in the training of the generative model, so that microscope images for which no associated registered microscope images are available can be used as training images. In particular, it is possible to use two image data sets that were not captured using the same samples but different samples.

The imaging/image property in which the microscope images of the image data sets differ can relate to one or more of the following:
a contrast type of a microscopic measurement method or a chemical staining of a sample. Examples of possible contrast types are: differential interference contrast (DIC), phase contrast, bright field, or fluorescence. Microscope images that differ in visible fluorescent dyes can also be regarded as images of different contrast types in this sense. By means of chemical stainings, e.g. a haematoxylin-eosin (HE) staining or an immunohistochemistry staining, certain structures of an observed sample are stained so as to make them more visible in a subsequently captured microscope image.
a resolution. The image data sets can differ in a measurement resolution. The respective measurement methods by means of which different resolutions are achieved can be the same or different. The PSF of the system differs for an imaging with different optical resolutions. For example, objectives with different magnifications can differ in distortion or other imaging errors. In cases where images of different resolutions are used to train a model, the model thus also learns to take into account the effect of the PSF, in contrast to the simple case where the low-resolution training images are created computationally by scaling down higher-resolution images.
imaging parameters of an employed microscopy system. The imaging parameters can relate, e.g., to the illumination, in particular an exposure time, illumination intensity, illumination wavelength(s) or illumination pattern, or to the detection, e.g. a detector readout time/rate, detector sensitivity or detection wavelength(s).
an employed microscopy system. Different microscopy systems can differ in terms of basic type (e.g. light, atomic force and electron microscope), or in the employed measurement principle and/or the employed components.
an image contrast. Different image contrasts can be achieved, e.g., by using different illumination or detection settings, or by combining a plurality of images of the same scene into an image with a higher contrast.
a convolution by a point spread function (PSF) underlying the microscope images. In the capture of a microscope image, the convolution between the point spread function of the employed optical system and an object point describes how this object point is represented in the microscope image. If the PSF is known, the influence of the PSF can be removed computationally by means of an image deconvolution, which improves the image quality. The image data sets can differ in the PSF of the optical system used for imaging and/or in a deconvolution already performed on captured raw images to calculate the microscope images. The microscope images thus differ in the strength of a blurring effect due to an underlying PSF.
a focal position. The image data sets can differ in the focal position represented by the microscope images in relation to objects under analysis. For example, they can show sample layers of different depths. Alternatively or additionally, the image data sets can also differ in a focal position of the employed measurement system, for example in a relative position between the illumination focus and the detection focus (plane).
a light scattering. Different light scattering patterns in the capture of the microscope images of the different image data sets can be used to create, e.g., training data for a descattering calculation by means of which the influence of interfering light scattering is removed. Light scattering can occur in particular in a sample medium or in a medium between the sample and a detection camera or between the sample and an illumination light source.
a light field measurement. For example, one of the microscope images can be generated by means of a light field measurement in which a plurality of images are captured with a different depth focusing. This can be brought about, e.g., when a first objective generates an intermediate (3D) image and a plurality of microlenses are directed at the intermediate 3D image, wherein the microlenses have different focal lengths. Camera chips behind the microlenses thus capture 2D images with a different depth focusing of the intermediate 3D image. These 2D images of the camera chips are used to compute a (3D) result image, which contains sharp image information for different depths. The other of the microscope images can be captured without a light field measurement. Such a pair of microscope images (when the microscope images are registered) can serve as training data for a model for a light field calculation by means of which a model replicates the effect of a light field measurement. Alternatively, one of the microscope images can correspond to the entire image data captured by the camera chips behind the microlenses during a light field measurement, while the other of the microscope images corresponds to a result image calculated from the image data of a light field measurement. When such a pair of registered microscope images is generated, it can be used to train an image processing model that replicates the calculations performed in a light field measurement to generate a result image.

### Training Image Pairs for an Image Processing Model

The registered image pairs created by the generative model can serve as training data for an image processing model which performs the actual desired task (e.g. virtual staining). The image processing model can be implemented using an established and well-understood method. Artefacts and hallucinations (i.e. the invention of structures that are not contained in the original image data and the actual sample) thereby occur far less frequently and can be better prevented than if the generative model were used for this task.

### Image Processing Model

An image processing model can be learned using training data that contains registered microscope images created by means of the generative model.

In particular, a method for providing an image processing model can comprise that a plurality of pairs of registered microscope images that differ in an imaging/image property are first generated by carrying out the described method according to the invention. Each pair thus comprises two generated microscope images which are co-registered and which differ (solely) in the imaging/image property. One pair differs from another pair in the depicted microscopic objects, e.g. with respect to the number, size and arrangement of the microscopic objects. The plurality of pairs of registered microscope images are used as training data for an image processing model. In particular, for each pair, one of the microscope images can be used in the training as an input image and the other of the microscope images can be used as a target image. This trains the image processing model to calculate a modification of an imaging/image property of an input microscope image. The image processing model thus outputs a processed microscope image that has been modified in the imaging/image property compared to the input microscope image.

For example, the image data sets used in the training of the generative model can differ in the imaging/image property “image sharpness”. The ready-trained generative model can thus generate registered microscope images that differ in image sharpness. An image pair thus comprises a microscope image of lower image sharpness and a co-registered microscope image of higher image sharpness. The microscope image of lower image sharpness is used as an input image in the training of the image processing model. The microscope image of higher image sharpness, on the other hand, is used as a target image in the training of the image processing model. The image processing model thus learns to sharpen the image. If a microscope image (of low image sharpness) is input into the ready-trained image processing model, the image processing model calculates a microscope image of a higher image sharpness from the same.

To put this more generally, a microscope image that was not seen in the training can be input into the image processing model in the inference phase, i.e. after completion of the training. The image processing model takes the microscope image and calculates an output image that corresponds in type to the target images of the training, i.e. the output image corresponds to the imaging/image properties of the target images.

The imaging/image property in which the registered microscope images differ determines an effect of an image processing model trained with these registered microscope images. Example image processing models are explained in the following:
Virtual staining/modification of the contrast type: The image processing model can be trained to calculate a virtually stained image (or, more generally, a microscope image with a modified contrast type) from an input microscope image, i.e. to calculate a microscope image that corresponds to a chemical staining. To this end, pairs of registered microscope images that differ in the imaging/image property “contrast type” are used in the training of the image processing model. In contrast to conventional approaches, it is not necessary for corresponding/registered images with different contrasts to be captured in order to provide the training data of the image processing model. This saves time and preserves the sample. In addition, it becomes possible to use existing image collections for which there are only images in one of the two contrast types, whereas to date it was not possible to use such image collections. Traditionally, in order to train image processing models which replicate a chemical staining (e.g. calculate a mapping of a widefield image to an HE/IHC staining), it has been necessary to image the same tissue twice, once unstained and then chemically stained, and to co-register the two images. This involves a risk of potential deformations, damage or changes caused by the staining process. In contrast, according to the invention, a sample can contribute to the data set either stained or unstained. This makes it possible to reuse samples that have already been treated for a target staining so that the original contrast is no longer available or retrievable.
High resolution: The image processing model can be trained to calculate an image of a higher resolution from an input microscope image. To this end, pairs of registered microscope images that differ in the imaging/image property “resolution” are used in the training of the image processing model.
Contrast enhancement: The image processing model can be trained to calculate a contrast-enhanced image from an input microscope image. To this end, pairs of registered microscope images that differ in the imaging/image property “image contrast” are used in the training of the image processing model.
Deconvolution: The image processing model can be trained to calculate an image deconvolution from an input microscope image. To this end, pairs of registered microscope images are used in the training of the image processing model which differ in the underlying convolution by a point spread function to which they correspond.
Change in focal position: The image processing model can be trained to calculate an image with a changed focal position from an input microscope image. To this end, pairs of registered microscope images that differ in the imaging/image property “focal position” are used in the training of the image processing model.
Descattering: The image processing model can be trained to calculate a reduction of a light scattering effect for an input microscope image, which is also called a descattering calculation. To this end, pairs of registered microscope images that differ in the imaging/image property “light scattering” are used in the training of the image processing model.
Light field measurement calculation: The image processing model can be trained to perform a light field measurement calculation for an input microscope image. To this end, pairs of registered microscope images are used in the training of the image processing model, only one of which represents a result image of a light field measurement.
Image-to-image mappings: The image processing model can also be trained to calculate image-to-image mappings other than those described thus far from an input microscope image. To this end, the pairs of registered microscope images used in the training of the image processing model can differ in which employed microscopy system for imaging they correspond to, which imaging parameters (e.g. illumination/detection parameters) of an employed microscopy system they correspond to, or which imaging type of an employed microscopy system they correspond to.
Artefact removal: The generated microscope images can also serve as training data for an image processing model that removes artefacts.

In addition, registered image pairs created with the generative model can be used for data augmentation. A data augmentation allows slight variations of microscope images to be created so that a training can be carried out on a more extensive data basis. Such variations can be achieved, e.g., by varying the object feature variables or the imaging-property feature variables.

The registered image pairs can also be used for a domain adaptation, in which an algorithm is applied to a similar application with the help of generated image pairs.

The described generation of registered training data for image-to-image applications is particularly advantageous with regard to time and cost expenditure.

### Annotation Transfer

Annotations (e.g. segmentation masks or specifications of image coordinates of the centers of depicted objects) can be provided for microscope images. If registered microscope images are generated for these microscope images, the annotations also apply to the generated microscope images. Annotations can thus be transferred to generated microscope images largely without manual effort. As the provision of annotations is often associated with a high level of manual effort, the described transfer of annotations represents a significant saving in terms of work.

More specifically, a plurality of pairs of registered microscope images which correspond to different imaging parameter values are first generated. Imaging parameter values are understood to be different values of an imaging parameter, e.g. different sharpnesses of the imaging parameter “image sharpness” or different contrast types (fluorescence, bright field, phase contrast, etc.) of the imaging parameter “contrast type”. Annotations are provided for the microscope images for one of the image parameter values. In principle, the annotations can be created in any manner, e.g. manually, semi-automatically or automatically by a program. The annotations are then transferred to the microscope images for the other of the imaging parameter values.

Optionally, two or more co-registered microscope images can be generated, one of which is subsequently (manually) annotated. Alternatively, the annotation transfer can be employed in the invention variant in which the generative model generates at least one registered microscope image for a provided microscope image, wherein the provided microscope image has not been created by the generative model. An annotation can already exist for the provided microscope image, whereupon this annotation is transferred to the at least one generated co-registered microscope image.

Annotations can generally be information regarding depicted objects, in particular information regarding the position, type or structure of an object. For example, the annotations can indicate at least one of the following:
Center points or boundaries of objects in microscope images;
Classifications relating to a depicted sample, a depicted sample carrier or other depicted structures, e.g., a type of the sample, a property of the sample, a property of the sample carrier type or a sample carrier part, or information as to whether retaining clips for a sample carrier are visible;
Segmentation masks relating to the microscope images. A segmentation mask designates an image in which different pixel values indicate different object classes. For example, in a binary mask, one pixel value can indicate that the corresponding pixel belongs to a sample, while the other pixel value indicates that the corresponding pixel does not belong to the sample.

The microscope images of one of the imaging parameter values can be used together with the annotations to train an image processing model, wherein the annotations are used in the training as target data. For example, the microscope images can be fluorescence images and the annotations can be segmentation masks so that the image processing model carries out a segmentation. The microscope images of the other of the imaging parameter values (e.g. phase contrast images) can also be used together with the annotations to train the image processing model or a further image processing model. This way, each annotation can be used for at least two different microscope images that are co-registered.

### Contextual Information

It is also possible to use contextual information in the described training processes. Contextual information is, e.g., information regarding an application, a user, an employed sample, an employed sample carrier or properties of the employed microscopy system. If this information is also taken into account in the training of the generative model or the image processing model, contextual information provided after completion of the training can be taken into account by the model in the calculation of generated microscope images or outputs of the image processing model.

Contextual information for a microscope image can be transferred to a co-registered microscope image if necessary. If registered microscope images differ in an imaging parameter that has no impact on the contextual information, the contextual information can be transferred from one of the registered microscope images to the other of the registered microscope images. For example, the imaging parameter has no impact on the contextual information when the contextual information relates to the employed sample or the employed sample carrier.

Analogously to the description of an annotation transfer, a given piece of contextual information can thus be used in the training of one or more image processing models for different co-registered microscope images.

### More than Two Co-Registered Microscope Images

The generative model can also be used to create groups consisting of more than two co-registered microscope images that differ in one or more imaging/image properties. To do this, microscope images that cover more than two different imaging/image property values—e.g. three different contrast types or chemical stainings—can be used in the training of the generative model.

In conventional methods, in contrast, a plurality of stainings cannot be represented in one model when one staining process prohibits another, e.g. due to an irreversible modification of the tissue. In the invention, on the other hand, different stainings can be taken into account in a common model and thus benefit from one another.

Descriptions according to which a pair of registered microscope images is generated are intended to be understood in the sense of at least two co-registered microscope images. A plurality of pairs of registered microscope images is accordingly intended to be understood as a plurality of groups consisting of at least two co-registered microscope images.

### Generative Model, Feature Vector

A generative model or generative network can generally be understood as a model or neural network that has been adapted so as to be able to generate from an input, in particular from a random input, images which appear to originate from a statistical distribution of provided microscope images of a training data set. Generated images thus correspond in type to the microscope images of the training data set.

In principle, a generative model can have any structure and can be formed, e.g., by a diffusion model. In the training of a diffusion model, noise of varying intensity is added to the training images, wherein the model learns a denoising or a separation of the image into a noise component and a signal component, whereby an image synthesis is learned. A feature space of the diffusion model can have a semantics.

The generative model can also be formed by a generator of a GAN or StyleGAN (GAN: generative adversarial network), as described in the introduction relating to the prior art. A GAN can also take the form of a Wasserstein GAN in which a modified—vis-à-vis classic GANs—loss function L is used. In principle, the generative model can also be structured in some other manner, for example, by a decoder of an autoencoder or of a variational autoencoder, by so-called active appearance models, or by methods based on a principal component analysis (PCA).

In the training of the generative model, the parameterization of the object positions (or, more generally, of the object properties such as object number, object type, object size, object shape and object position) should be strictly separated from the parameterization of other image features, which are referred to in the present disclosure as imaging/image properties and relate, e.g., to contrast type, brightness, sharpness, etc. Simple GANs represent a potential model class for implementing this. StyleGANs represent a simple way of ensuring that object properties and imaging/image properties are expressed by different feature variables. Due to their architecture, there is a division into stochastic parameters and abstract parameters with StyleGANs. In order to generate two registered microscope images, the stochastic parameters (which are or contain the imaging-property feature variables and thus encode, inter alia, the object positions) can be kept constant. These parameters or variables are thus set to random or specific values, which are used identically for the generation of two microscope images, so that the microscope images show identical objects at identical positions and are consequently registered. The stochastic parameters or at least a subset of the stochastic parameters that is responsible for the object properties can generally be fixed in order to generate a registered image pair.

In the training, there can be a further neural network upstream of the generative model. If the generative model is the generator of a StyleGAN, a mapping network is used first, for example. The mapping network can comprise, e.g., a plurality of fully-connected layers and uses input data to create an output, which is input into the generator. The mapping network thus performs a mapping of input data, i.e. a mapping of a random vector/feature vector z from a feature space Z to a (feature) vector w in another feature space W. The feature space W can be better adapted to the training image data compared to the feature space Z, so that feature variables or axes of the feature space W are better separated from one another than the axes of the feature space Z with respect to the image properties they encode.

“Feature vector” designates input data that is input into the generative model in order to generate a microscope image therefrom. The feature vector comprises a plurality, e.g. thousands, of independent variables, which are called feature variables. In the present disclosure, all variables that are input at any point into the generative model should be understood collectively as a feature vector. In the case of a StyleGAN2, the feature vector accordingly comprises the stylizing vector in the Z or W space as well as the added noise. The noise can in particular be provided as an image, which is added in different scalings in the different layers of the generative network. A value from the W-space influences the image synthesis via an affine mapping and an adaptive instance normalization (AdaIN) in a plurality of layers. The image synthesis can start with a constant (a tensor with constant values), wherein the constant was learned in the training of the generative model and is thus identical for the different generated microscope images.

In variants of this StyleGAN architecture, for example in the architecture known as Alias-Free StyleGAN, there is no addition of noise in different layers. The image synthesis thus does not start with a learned constant, but with variables that encode the object positions or object properties. These variables represent Fourier features because their values relate to different image frequencies via a Fourier mapping, analogously to a Fourier series. This means that even high-frequency image content, e.g. sharp edges and small objects, can be described with just a few variables. The Fourier features can be or comprise the variables referred to in the present disclosure as object feature variables.

It can thus be predetermined by the model architecture which variables encode object positions and other object properties. The identification of object feature variables in these cases can be predetermined by the model architecture, so that, for example, the noise inputs of a StyleGAN2 or the Fourier features of an Alias-Free StyleGAN can be used as object feature variables. All other input data can be identified as imaging-property feature variables.

In addition, or with other model architectures, the influence of different feature variables on generated images can be ascertained by exploring the feature space (latent space). This makes it possible to identify the feature variables that encode object positions and other object properties. If the division of feature variables into object feature variables and imaging-property feature variables is based on an exploration of the feature space, this division is carried out after the training of the generative model. The chronology is conversely irrelevant when the identification of feature variables as object feature variables or as imaging-property feature variables is based on the model architecture.

For certain values of an imaging/image property, it is possible to ascertain typical values of the associated imaging-property feature variables. Microscope images (e.g. of the training data of the generative model) have a given value of an imaging/image property, for example contrast type=phase contrast or contrast type=fluorescence. By back-projecting these microscope images, it is possible to determine the corresponding imaging-property feature variables. The imaging-property feature variables for a plurality of microscope images of a given value of the imaging/image property (e.g. for the microscope images with the contrast type =phase contrast) are averaged. These averaged imaging-property feature variables can be used in the image synthesis so that the generative network generates a microscope image with the desired value of the imaging/image property, e.g. a microscope image of the contrast type “phase contrast”. Instead of averaging, it is also possible to determine a distribution of the calculated values of the imaging-property feature variables and for random values from this distribution to be selected for the imaging-property feature variables in the image synthesis. This makes it possible to achieve a higher bandwidth of the generated microscope images.

If the desired classification of the feature variables is not already inherent in the model, it is also possible to integrate boundary conditions into the optimization process, in particular into the loss for non-stochastic features. For example, the distribution of objects in a mini-batch in relation to one another can be taken into account. A mini-batch refers to the set of training image pairs for determining a gradient update during the training. The similarity of the distribution of objects in a mini-batch can be minimized while the variance of the abstract parameters is simultaneously maximized.

An output of the generative model is or comprises an image. For the sake of brevity, different embodiments are described in which one image is output. More generally, this should be understood in the sense of “at least one” image so that, depending on its design, the generative model can also output a plurality of images or three-dimensional/volumetric image data from one input.

### Generating a Registered Image for a Provided Image

In different variants of the invention, one or more microscope images are provided. The provided microscope images can be the microscope images of one of the image data sets of the training of the generative model, or other microscope images. The provided microscope images are captured with a given value of an imaging/image property, e.g. with the contrast type “phase contrast”. It is intended to generate co-registered microscope images with a different value of the imaging/image property, which correspond, e.g., to the contrast type “fluorescence”. A back-projection of a provided microscope image into a feature space can be carried out to this end. This can be understood to mean that the values of feature variables are calculated which, when entered into the generative network, would result in a microscope image that is ideally identical to the provided microscope image. The values of the feature variables that are identified as object feature variables are used for the image synthesis, but not the values of the imaging-property feature variables of the provided microscope image (which encode, e.g., a representation according to the contrast type “phase contrast”). Instead, values of the imaging-property feature variables which are typical for a different value of the imaging/image property are used, for example for the contrast type “fluorescence”. This way, an artificial microscope image can be generated which is registered in relation to the provided microscope image and which corresponds to a difference in at least one imaging/image property.

### General Features

Registered microscope images: Two (co-) registered images can be understood to mean that objects depicted in the images are shown at the same coordinates within the images.

For example, if the center point of an object in an image has the coordinates (100, 100), then the center point of the object in each co-registered image also has the same coordinates (100, 100).

The formulation according to which registered microscope images are generated is intended to comprise the variant that all these registered microscope images are created by the generative model. The formulation is also intended to comprise the variant that a non-generated, provided microscope image is present and the generative model generates at least one co-registered microscope image. The terms “create” and “generate” are used interchangeably.

A pre-processing of a data set is possible before the corresponding images are used to train the generative model. A pre-processing can comprise, for example, a filtering-out of images that are unsuitable for the defined task or an adjustment of the image scalings. Bringing the objects (e.g. the cells) in the training images to approximately the same size by scaling the images in a pre-processing step simplifies the subsequent training.

A microscope image is understood to be an image that is captured by a microscope or calculated using measurement data of a microscope. The microscope can be, for example, a light microscope, an electron microscope or an atomic force microscope. The microscope image can in particular be formed by one or more raw images or already processed images of the microscope. The microscope image can also be an overview image of an overview camera on the microscope or be calculated from measurement data of at least one overview camera.

Objects depicted in microscope images can in principle be of any type, e.g. biological structures, electronic elements or rock areas. The object types, an object density and a number of objects can differ in a training data set. For example, different types of biological cells can be depicted in the microscope images of the training data set.

The computing device can be designed in a decentralized manner, be physically part of the microscope or be arranged separately in the vicinity of the microscope or at a remote location at any distance from the microscope. It can generally be formed by any combination of electronics and software and can in particular comprise a computer, a server, a cloud-based computing system or one or more microprocessors or graphics processors. The computing device can also be configured to control microscope components.

Method variants can optionally comprise the capture of microscope images by the microscope, while in other method variants existing microscope images are loaded from a memory.

Descriptions in the singular are intended to cover the variants “exactly 1” and “at least one”. Descriptions according to which a microscope image is input into one of the described models are intended to comprise, for example, the possibilities that exactly one or at least one microscope image is used. A common processing of a plurality of microscope images can be appropriate, e.g., when the microscope images form an image stack (z-stack), whereby sample layers of the same sample that are at a distance from one another are shown, or when the microscope images are successive images of the same sample. Volumetric image data should also be understood in the sense of the present disclosure as one or more microscope images.

A generative model and other learned models described herein can be learned by a learning algorithm using training data. The models can, for example, respectively comprise one or more convolutional neural networks (CNN), which receive a vector, at least one image or image data as input. Model parameters of the model are defined by means of a learning algorithm based on the training data. To this end, a predetermined objective function is optimized, e.g. a loss function is minimized. To minimize the loss function, the model parameter values are modified, which can be calculated using, e.g., gradient descent and backpropagation. In the case of a CNN, the model parameters can in particular comprise entries of convolution matrices of the different layers of the CNN. Other model architectures of a deep neural network are also possible.

The characteristics of the invention that have been described as additional apparatus features also yield, when implemented as intended, variants of the methods according to the invention. Conversely, a microscopy system or in particular the computing device can be configured to carry out the described method variants. Further variants of the invention result from the intended use of the described learned models, for example a use for image processing.

### BRIEF DESCRIPTION OF THE DRAWINGS

A better understanding of the invention and various other features and advantages of the present invention will become readily apparent by the following description in connection with the schematic drawings, which are shown by way of example only, and not limitation, wherein like reference numerals may refer to alike or substantially alike components:

FIG. 1 is a schematic representation of a learning process of a generative model according to an example embodiment of a method according to the invention;

FIG. 2 schematically shows different training data sets, which respectively differ in an imaging/image property, for training a generative model according to example embodiments of a method according to the invention;

FIG. 3 schematically illustrates processes for identifying a semantics of feature variables of a trained generative model according to example embodiments of a method according to the invention;

FIG. 4 schematically illustrates the generation of registered image pairs by a generative model and the use of the image pairs for training an image processing model, according to example embodiments of a method according to the invention;

FIG. 5 schematically shows processes for automatically transferring an annotation to a generated microscope image; and

FIG. 6 schematically shows an example embodiment of a microscopy system according to the invention.

### DETAILED DESCRIPTION OF EXAMPLE EMBODIMENTS

Different example embodiments are described in the following with reference to the figures. As a rule, similar elements and elements that function in a similar manner are designated by the same reference signs.

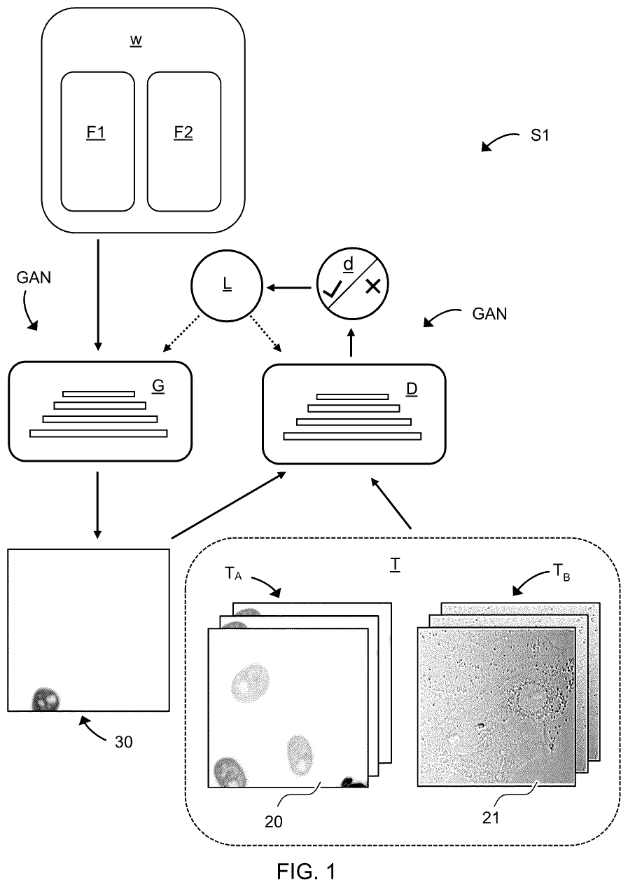

### FIG. 1

With reference to FIG. 1, a training of a generative model within the framework of an example embodiment of a method according to the invention, step S1, is described. Training data T is provided, which is used to train a generative adversarial network GAN comprising a generative network G and a discriminator D.

The training data T comprises microscope images 20, 21, which are not co-registered, that is to say that neither the microscope image 20 nor the microscope image 21 is registered in relation to any image of the training data. The microscope images 20, 21 differ in an imaging/image property, e.g. a contrast type, with which the microscope images were captured. Microscope images 20 with a certain value of the imaging/image property (e.g. “contrast type”=fluorescence image) can be called image data set T_{A}, while microscope images 21 which differ from the former in the imaging/image property (e.g. “contrast type”=phase contrast image) are called image data set T_{B}. The image data sets T_{A} and T_{B} can be provided as a common data set, so that the microscope images are in particular intermixed, or as separate data sets. The image data sets T_{A} and T_{B} can be intermixed or used alternately, e.g. in different training epochs, in the training of the GAN.

The generative network G is intended to be able to create generated images (microscope images) 30 which are indistinguishable from the microscope images 20, 21 of the training data T. Indistinguishable can be understood in the sense that generated images 30 appear to come from the same distribution as the microscope images 20, 21, so that the discriminator D is unable to distinguish generated images 30 from the microscope images of the training data T.

The structure of the generative network G of the GAN can be designed in a manner known per se, for example as described in the introduction with respect to StyleGAN, StyleGAN2 or Alias-Free StyleGAN. More generally, the generative network G comprises in particular convolutional layers, corresponding to a CNN (convolutional neural network), wherein the generative network G can also be generated in some other way than by a GAN structure. For example, the generative network G can also be designed as a variational autoencoder or diffusion model (e.g., as a denoising diffusion model or diffusion autoencoder).

The training of the generative model G is described in the following based on the microscope images 20, 21 in a GAN structure.

A start vector, referred to here as feature vector w, is input into the generative network G. Depending on the structure of the generative network G, the entire feature vector w does not have to be input exclusively into a first layer of the generative network G. Rather, the feature vector or parts of the same can work in different layers of the generative network G. A feature vector w is intended to be understood here as all variables that are input into the generative network G from outside. In the case of a generative network of a StyleGAN2, this also includes, e.g., noise used in different layers of the generative network.

In this example, an output of the generative network G is a two-dimensional image, which is called a generated microscope image 30 in the present disclosure.

Either a (real) microscope image 20, 21 or a generated microscope image 30 is input into the discriminator D. An output of the discriminator D should be a discrimination result d which indicates whether the discriminator D classifies an input image as a real microscope image or as a generated microscope image. The discrimination result d is taken into account in a loss function L. In order to adapt model parameter values (weights) of the generative network G, the loss calculated by the loss function L is passed by means of backpropagation through the layers of the discriminator D and subsequently through the layers of the generative network G, whereby gradients for modifying the respective model parameter values are obtained for each layer. To adapt the generative network G in a training step, typically only the model parameter values of the generative network G, e.g. entries of its convolution matrices, are modified, while the discriminator D remains unchanged. In a training step for the discriminator D, the loss calculated by the loss function L is used via backpropagation to adapt model parameter values of the discriminator D. Different loss functions can be used in the training, namely a generator loss function for the generative network and a discriminator loss function for the discriminator D. These can be derived from the same loss function L, e.g. by leaving out the parts of the loss function L in the training of the generative network G which relate to discrimination results d for input real microscope images 20, 21. In the training of the generative network G, its model parameter values are modified so that the discriminator D is unable to distinguish generated microscope images 30 from real microscope images 20, 21.

Upon completion of the training, the generative network G is able to generate realistic microscope images from different feature vectors w. Training the generative network G gives structure to a space of the feature vector, that is to say that points or vectors in this space that are close together result in similar microscope images, while points that are further apart from one another result in very different microscope images. The space is spanned by a plurality of axes or feature variables, which influence a microscope image generated by the generative network G in different ways.

Some of the feature variables relate to the number, coordinates, shapes and structural properties of depicted objects, for example biological cells. These feature variables are called object feature variables F1 in the following. Other feature variables relate to the manner in which the objects are represented and are called imaging-property feature variables F2. A difference in the imaging/image property of the microscope images 20, 21 is reflected in the imaging-property feature variables F1. For example, the image data sets T_{A} and T_{B} can differ in the imaging/image property “contrast type”, in particular in terms of whether fluorescence images or phase contrast images are present. In this case, the imaging-property feature variables F2 describe a representation of the microscopic objects, either as a fluorescence image or as a phase contrast image.

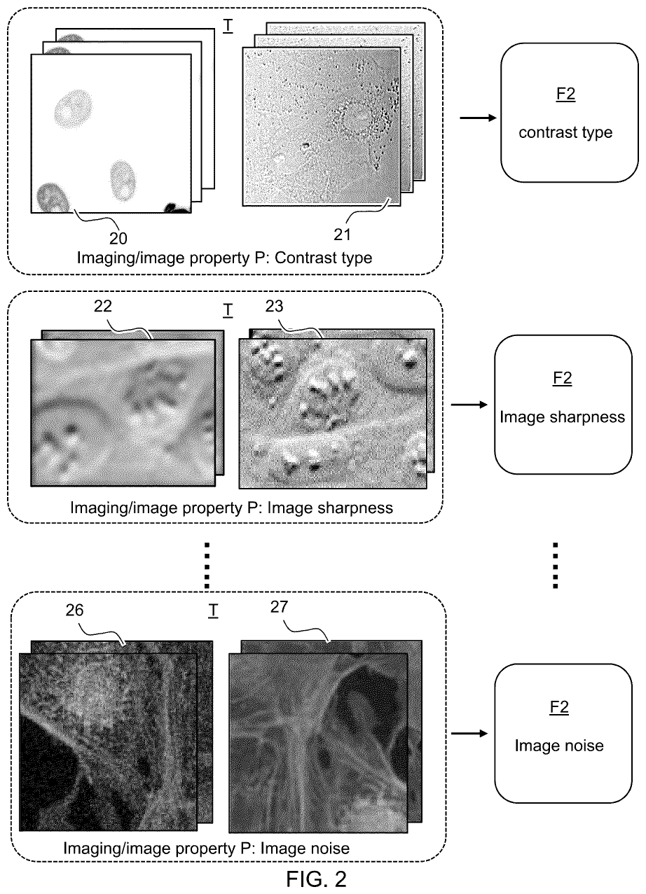

Examples of training data of the generative network and the resulting meaning of imaging-property feature variables F2 are described with reference to FIG. 2.

### FIG. 2

FIG. 2 illustrates how different meanings of feature variables follow from different image data sets of the training data T. The effect of the feature variables input into the ready-trained generative network G depends on the training data T of the generative network G used.

In all cases, the microscope images 20, 21 of the training data T are not co-registered.

In one example, the microscope images 20, 21 of the training data T are captured with different contrast types, e.g. as fluorescence and phase contrast images. The imaging/image property P in which the microscope images 20, 21 differ is thus the contrast type. If a generative model G is trained with this training data T, certain feature variables, which are referred to as imaging-property feature variables F2, define the contrast type for an image generated from a feature vector (which comprises the imaging-property feature variables F2). Depending on the selection of the values of F2, a generated microscope image corresponds to a phase contrast image or a fluorescence image. By setting the object feature variables in both cases to the same values, it is possible to generate two co-registered microscope images which correspond to different values of the imaging/image property P, as described in greater detail later on.

The imaging/image property P can also be, e.g., an image sharpness. In this case, the microscope images 22, 23 differ in their image sharpness. For a generative model G that is trained with these microscope images, certain imaging-property feature variables F2 define the image sharpness with which a microscope image 30 is generated.

The microscope images 26, 27 differ in image noise, i.e. the imaging/image property P relates to the image noise here. These microscope images can be used to learn a generative model G in which certain imaging-property feature variables F2 define, inter alia, a noise of a generated microscope image 30.

A generative model G can also be trained with training data T containing microscope images that differ in a plurality of imaging/image properties P. The generative model G is thus able to generate registered microscope images that differ in one or more of the imaging/image properties P.

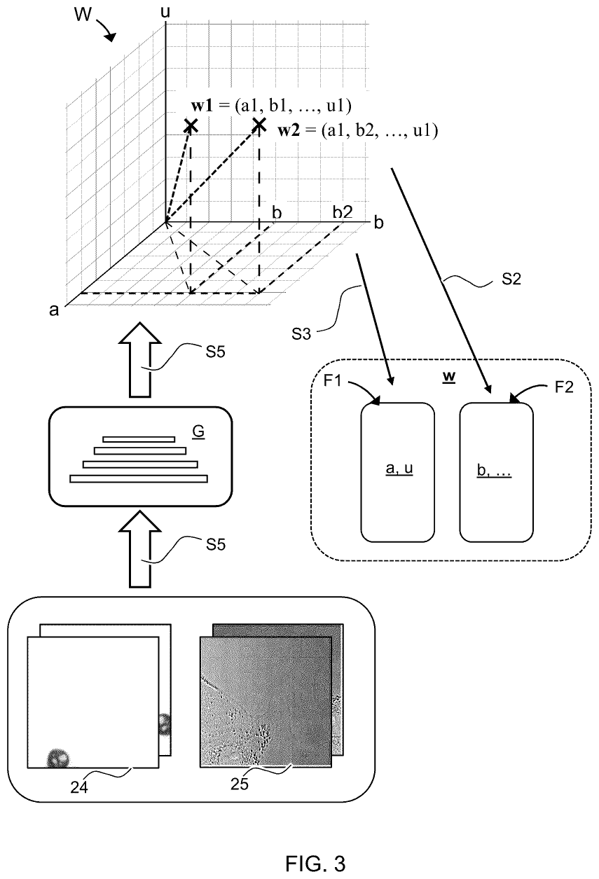

A meaning of feature variables can be predetermined and known through the architecture of the generative model M, and/or can be ascertained through analyses, as explained in the following with reference to FIG. 3.

### FIG. 3

FIG. 3 illustrates a procedure for ascertaining a meaning of feature variables of a ready-trained generative model M. In this example, co-registered microscope images 24, 25 are used. The number of existing registered microscope images 24, 25 can be very small compared to the number of images in the training data T. The microscope images 24, 25 show the same sample, wherein a given sample point has the same image coordinates in both microscope images 24, 25. The microscope images 24, 25 differ in at least one imaging/image property.

For each of the registered microscope images 24, 25, a back-projection into the feature space W is calculated, which is also referred to as a latent code or latent code representation of the microscope images 24, 25, step S5. Procedures for ascertaining a latent code representation for a provided (microscope) image 24, 25 are known per se. For example, a feature vector can be input into the generative network G with random or predetermined starting values. A difference between an image generated from the feature vector and the provided microscope image 24 is then determined. An adjustment of the values of the feature vector is performed as a function of this difference. This can be calculated using a gradient descent method, also known as projected gradient descent (PGD). The feature vector is modified iteratively in this manner until differences between a microscope image generated therefrom and the provided microscope image 24 have been minimized.

FIG. 3 shows schematically a feature space W, which is spanned by feature variables a, b, . . . u. The latent code (feature vector) w1 was ascertained for the microscope image 24 by back-projection, i.e. specific values a1, b1, . . . u1 were calculated for the feature variables. Analogously, specific values a1, b2, . . . u1 of the feature variables were ascertained for the microscope image 25. Since the microscope images 24, 25 are co-registered, information regarding depicted objects, e.g. object positions, object sizes and object shapes, is identical in both cases. Feature variables in which the two feature vectors w1 and w2 have identical values can thus be identified as object feature variables F1, step S2. Alternatively, it is possible to check the effect on generated images of the feature variables in which the two feature vectors w1 and w2 have identical values manually so that certain feature variables a, u can be identified as object feature variables F1.

All remaining feature variables in which the feature vectors w1 and w2 differ or differ by more than a threshold value can be identified as imaging-property feature variables, step S3. The procedure described for two registered microscope images 24, 25 can be carried out for a plurality of such image pairs in order to identify object feature variables F1 and imaging-property feature variables F2 particularly reliably.

By back-projecting existing microscope images (e.g. the microscope images of the training, which do not have to be registered), it is also possible to analyze imaging-property feature variables in more detail. For example, the feature vectors of microscope images from two groups that are known to differ in an imaging/image property can be calculated via back-projection. For each group, a distribution (e.g., respectively a mean and a variance for each) of the imaging-property feature variables is calculated. This distribution indicates the typical values of the imaging-property feature variables for a given value of an imaging/image property, e.g. for the contrast type “fluorescence” or the contrast type “phase contrast”. To generate a microscope image with a given value of an imaging/image property, e.g. a fluorescence image, random or specific values can be generated from the associated distribution and input into the generative model.

It is also possible to calculate the difference between the above-mentioned mean values of one group and the mean values of the other group. This difference represents a vector that indicates the transition from one value of the imaging/image property to another value of the imaging/image property. For example, the vector can cause the transition of a microscope image of a given contrast type to a co-registered microscope image of another contrast type. In order to generate an image from a provided microscope image which displays the objects of the provided microscope image in a different contrast type, it is thus possible to calculate the latent space representation of the provided microscope image, which is then modified by the aforementioned difference and then input into the generative model. This is also described in more detail later on.

The outlined procedure for exploring the feature space can be used in particular for a generative network of a StyleGAN. However, it is also possible for it to already be defined by the design of the generative model which feature variables encode object information and which feature variables are responsible for the style of the representation, i.e. for the effect of the imaging/image properties on the representation of the objects. For example, images are generated in a trained generative model of a StyleGAN2 starting with a constant start vector. Noise is added over a plurality of layers of the generator (per-layer noise maps). In addition, a feature vector acts in each layer via an affine transformation and subsequent adaptive instance normalization (AdaIN), which normalizes an average and a variance of a respective feature map of a layer.

A learned generative model of a StyleGAN2 separates image features into abstract and stochastic properties. Positions of objects in the microscope image, inter alia, are learned as stochastic features, while all features relevant for a microscopy application are classified as non-stochastic (abstract) features. By keeping the feature variables constant for all stochastic features but varying the abstract features, it is possible to generate registered microscope images with differences in the imaging parameters. The inputs known typically as noise images, which are added per layer in a StyleGAN2, can comprise, i.e. be or contain, the object-property feature variables.

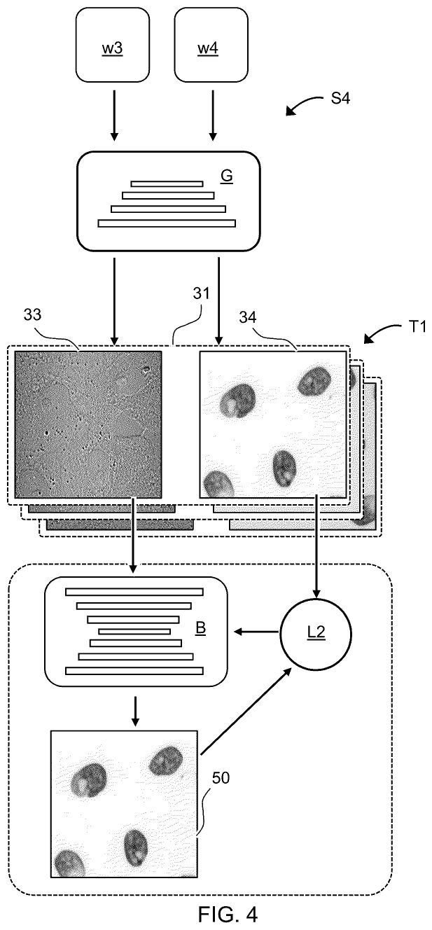

### FIG. 4

FIG. 4 illustrates method processes of a method according to the invention for generating pairs 31 of registered microscope images 33, 34, step S4. The registered microscope images 33, 34 are subsequently used as training data T1 for an image processing model B.

First, a feature vector w3 is input into the ready-trained generative network G, which calculates a microscope image 33 from the same. A feature vector w4 is subsequently input into the generative network G, which calculates a microscope image 34 therefrom. Both feature vectors w3 and w4 are selected with identical values of the object feature variables. The specific values of the object feature variables can be randomly selected so long as the same values are selected for w3 and w4. In the imaging-property feature variables, on the other hand, w3 and w4 differ. For example, for w3, values of the imaging-property feature variables can be drawn from a distribution which was ascertained beforehand and which is typical for a given value of an imaging/image property, as explained with reference to FIG. 3. Values of the imaging-property feature variables that are typical of a different value of the imaging/image property are likewise selected for w4. The two values of the imaging/image property can indicate, e.g., different image sharpnesses, or different contrast types.

As a result, the generated microscope images 33, 34 are co-registered, i.e. they show the same microscopic objects at the same image coordinates, but differ in the value of the imaging/image property, e.g. in the image sharpness or contrast type.

In this manner, a plurality of pairs of registered microscope images 33, 34 are generated which differ in the imaging/image property. One pair differs from another pair in the depicted objects. These image pairs are now used as training data T1 for an image processing model B that requires co-registered image pairs for its training.

In particular, the microscope images 33 can be used as input data of the image processing model B, while the microscope images 34 serve as associated target images of the image processing model B. For example, microscope images of the contrast type “phase contrast” (or alternatively microscope images of a lower sharpness) are input into the image processing model B, which is trained to calculate therefrom result images 50 or more generally image processing results which ideally correspond to the target images, i.e. to the microscope images of the contrast type “fluorescence” (or to the microscope images of a higher sharpness). During the training, a loss function L2 captures differences between generated result images 50 and corresponding target images. An adjustment of the model parameter values of the image processing model B is carried out in each training step as a function of these differences.

This way, an image processing model B that requires registered training images can be trained with little manual effort and cost-effectively. Existing image data sets that correspond in their imaging/image property solely to the input images or to the output images of the image processing model B (e.g. a data set of fluorescence images for which no registered phase contrast images are available) can be utilized as described for the generative model and thus for the training of the image processing model B. This is a significant advantage over conventional methods, which require registered image pairs.

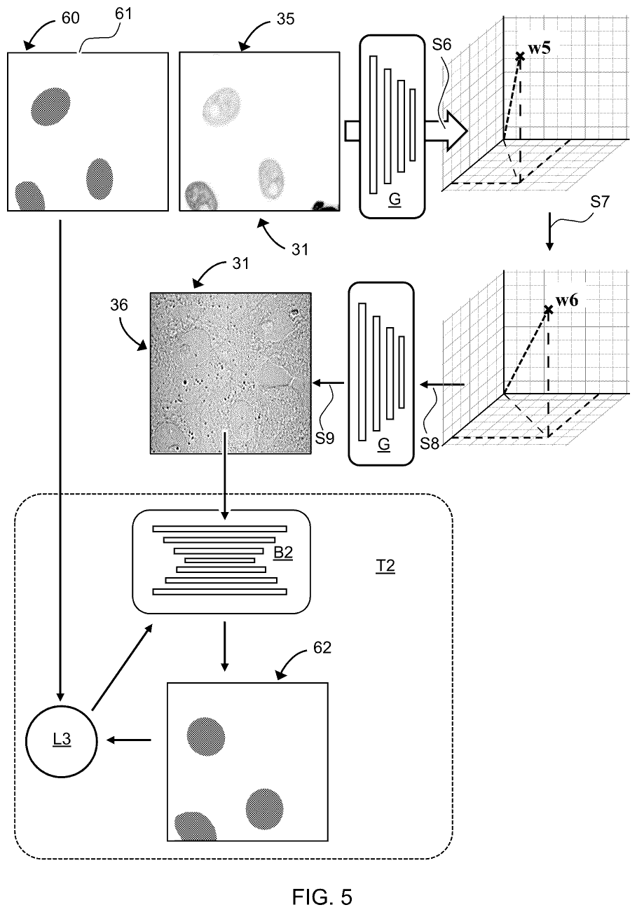

### FIG. 5

The described generative network G can also be used for transferring annotations, as shown schematically in FIG. 5. A provided microscope image 35 and an associated annotation 60 are provided. The provided microscope image 35 is not generated by the generative model G in this case, but can rather be a captured microscope image, in particular one from the training data of the generative model. In this example, the annotation 60 is a segmentation mask 61 which distinguishes sample areas from a background. The segmentation mask 61 can be created, e.g., manually.

In step S6, a feature vector w5 (latent code representation) is calculated by back-projecting the provided microscope image 35. The feature vector w5, if input into the generative network G, would result in a generated microscope image which would be essentially identical to the provided microscope image 35.

In step S7, the feature vector w5 is modified in the values of its imaging-property feature variables, while the object feature variables are kept constant. This generates a feature vector w6 that corresponds to a different value of an imaging/image property. The feature vector w6 is input in step S8 into the generative model G, which uses it to calculate a generated microscope image 36. The generated microscope image 36 is registered in relation to the provided microscope image 35. The annotation 60 accordingly also applies to the generated microscope image 36.

The annotation 60 and the generated microscope image 36 can be utilized for a training T2 of an image processing model B2. The annotation 60 is used as target in the training, so that the image processing model B2 learns to calculate an image processing result corresponding to the annotation 60 from an input microscope image which corresponds in its type to the generated microscope image 36. In the illustrated example, the annotations 60 are segmentation masks 61, so that the image processing model B2 is a segmentation model which calculates a segmentation mask 62 as the image processing result. It is possible to use in the training, in a manner known per se, e.g., a loss function L3 by means of which differences between outputs of the image processing model B2 and the provided annotations 60 are captured and model parameter values of the image processing model B2 are adjusted as a function of the captured differences.

In the described manner, existing annotations for microscope images of one value of an imaging/image property (e.g. fluorescence images) can be transferred to generated microscope images of another value of the imaging/image property (e.g. phase contrast images). It is essential for this purpose that pairs 31 of registered microscope images 35, 36 are generated. An image processing model B2 which shall receive phase contrast images (or, more generally, microscope images with the other value of the imaging/image property) as input data can advantageously be trained in this manner without annotations having to be created manually for this type of images.

In principle, it is sufficient to determine the values of the object feature variables in step S6 without also determining specific values of the imaging-property feature variables. In this case, in step S7, the object feature variables are supplemented by the imaging-property feature variables of the desired imaging/image property.

An annotation transfer is also suitable when the two registered microscope images were both generated by the generative network in accordance with step S4 in FIG. 4. In this case, an annotation can be created, in particular manually, for one of the two registered microscope images. This annotation can subsequently also be utilized for the other generated microscope image of the pair. For example, a segmentation mask can be manually created as an annotation for a generated fluorescence image, which is one of the two registered microscope images. The segmentation mask can also be used for a generated phase contrast image, which in this example is the other of the two registered microscope images. It is thus possible to train two segmentation models which receive either phase contrast images or fluorescence images as inputs, or a common segmentation model which can segment phase contrast images and fluorescence images. This reduces the manual annotation effort compared to the conventional case in which each (unregistered) phase contrast image and fluorescence image would have to be segmented manually.

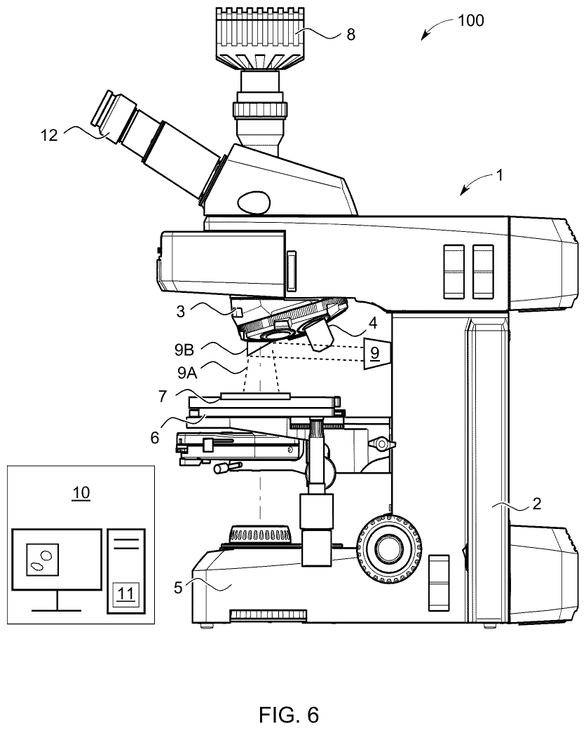

### FIG. 6

FIG. 6 shows an example embodiment of a microscopy system 100 according to the invention. The microscopy system 100 comprises a computing device 10 and a microscope 1, which is a light microscope in the illustrated example, but which in principle can be any type of microscope. The microscope 1 comprises a stand 2 via which further microscope components are supported. The latter can in particular include: an illumination device 5; an objective changer/revolver 3, on which an objective 4 is mounted in the illustrated example; a sample stage 6 with a holding frame for holding a sample carrier 7; and a microscope camera 8. When the objective 4 is pivoted into the light path of the microscope, the microscope camera 8 receives detection light from a sample area in which a sample can be located in order to capture a sample image. In principle, a sample can be or comprise any object, fluid or structure. The microscope 1 optionally comprises an additional overview camera 9 for capturing an overview image of a sample environment. A field of view 9A of the overview camera 9 is larger than a field of view when a sample image is captured. In the illustrated example, the overview camera 9 views the sample carrier 7 via a mirror 9B. The mirror 9B is arranged on the objective revolver 3 and can be selected instead of the objective 4. In variants of this embodiment, the mirror is omitted or a different arrangement of the mirror or a different deflecting element is provided.

The microscope images used in the training of the generative model can be captured by the microscope 1. The computing device 10 can be configured to carry out the described method variants or contain a computer program 11 by means of which the described method processes are executed. The computing device 10 can also comprise the described image processing model, so that microscope images captured by the microscope 1 are processed by the image processing model for, e.g., deconvolution, noise reduction, resolution enhancement, image sharpening, or mapping to a different contrast type.

The variants described with reference to the different figures can be combined with one another. The described embodiments are purely illustrative and variations of the same are possible within the scope of the attached claims.

### LIST OF REFERENCE SIGNS

1 Microscope
2 Stand
3 Objective revolver
4 (Microscope) objective
5 Illumination device
6 Sample stage
7 Sample carrier
8 Microscope camera
9 Overview camera
9A Field of view of the overview camera
9B Mirror
10 Computing device
11 Computer program
20,21 Microscope images of the image data sets T_{A}, T_{B}, which differ in the imaging/image property “contrast type”
22, 23 Microscope images which differ in the imaging/image property “image sharpness”
24, 25 Co-registered microscope images
26, 27 Microscope images which differ in the imaging/image property “image noise”
30 Generated microscope image
31 Pair of generated microscope images
30 Generated microscope image
33, 34 Generated co-registered microscope images
35 Provided microscope image
36 Generated, registered microscope image
50 Result image of the image processing model B
60 Annotations
61 Provided segmentation mask
62 Segmentation mask
a, b, u Feature variable
a1, b1, b2, u1 Values of feature variables
B, B2B Image processing model
D Discrimination result of the discriminator
D Discriminator of the GAN
W Feature space
w, w1-w6 Feature vectors
F1-F2 Feature variables of the feature vector
G Generative model
GAN Generative adversarial network
LV Loss function for training the GAN
L2 Loss function for training the image processing model B
L3 Loss function for training the image processing model B2
P Imaging/image property
P_{A}, P_{B} Different values of the imaging/image property P
S1-S7 Steps of methods according to the invention
T Training data/training data set
T_{A}, T_{B} Image data sets of the training of the generative model G
T1 Training data for the image processing model B
T2 Training of the image processing model B2

What is claimed is:

1. A computer-implemented method for generating pairs of registered microscope images, comprising:
training a generative model for creating generated microscope images from input feature vectors comprising a plurality of feature variables,
wherein the training is carried out with at least two image data sets, which respectively contain microscope images of microscopic objects but which differ in an imaging/image property;
identifying which of the feature variables are object feature variables, which define at least object positions of microscopic objects in generated microscope images;
identifying which of the feature variables are imaging-property feature variables, which determine an appearance of the microscopic objects in generated microscope images as a function of the imaging/image property and which do not influence the object positions in generated microscope images; and
generating, using the generative model, at least one pair of generated microscope images from feature vectors which correspond in their object feature variables and differ in the imaging-property feature variables, so that the generated microscope images of a pair show microscopic objects with corresponding object positions, but with a difference in the imaging/image property.

2. The method according to claim 1,
wherein the imaging/image property relates to at least one of the following:
a contrast type of a microscopic measurement method or a chemical staining of a sample;
imaging parameters of an employed microscopy system, which relate in particular to an illumination or detection;
an employed microscopy system;
a resolution;
an image contrast;
a convolution by a point spread function underlying the microscope images;
a focal position;
a light scattering;
a light field measurement.

3. A method for providing an image processing model, comprising:
carrying out the method according to claim 1 for generating a plurality of pairs of registered microscope images which differ in an imaging/image property; and
using the plurality of pairs of registered microscope images as training data for an image processing model, wherein, for each of the pairs in the training, one of the microscope images is used as an input image and the other of the microscope images is used as a target image, so that the image processing model is trained to calculate, from an input microscope image, a processed microscope image which corresponds to a change in the imaging/image property vis-à-vis the input microscope image.

4. The method according to claim 3,
wherein the image processing model is trained to take an input microscope image and:
calculate a virtually stained image or a microscope image with a different contrast type, to which end the pairs of registered microscope images used in the training differ in the imaging/image property “contrast type”;
calculate an image of a higher resolution, to which end the pairs of registered microscope images used in the training differ in the imaging/image property “resolution”;
calculate a contrast-enhanced image, to which end the pairs of registered microscope images used in the training differ in the imaging/image property “image contrast”;
calculate an image deconvolution, to which end pairs of registered microscope images are used in the training which differ in the underlying convolution by a point spread function to which they correspond;
calculate an image with a changed focal position, to which end pairs of registered microscope images used in the training differ in the imaging/image property “focal position”;
perform a descattering calculation/a calculation to reduce a light scattering effect, to which end pairs of registered microscope images used in the training differ in the imaging/image property “light scattering”;
perform a light field measurement calculation, to which end pairs of registered microscope images are used in the training, one of which represents a result image of a light field measurement.

5. The method according to claim 1, further comprising:
generating a plurality of pairs of registered microscope images corresponding to different imaging parameter values;
providing annotations for the microscope images of one of the imaging parameter values, wherein the annotations are created manually, semi-automatically or automatically by a program;
transferring the annotations to the microscope images of the other of the imaging parameter values.

6. The method according to claim 5,
wherein the annotations indicate at least one of the following:
segmentation masks for the microscope images;
center points or boundaries of objects in microscope images;
classifications relating to a depicted sample, a depicted sample carrier or other depicted structures.

7. The method according to claim 5,
wherein the microscope images of one of the imaging parameter values are used together with the annotations to train an image processing model, and
wherein the microscope images of the other of the imaging parameter values are used together with the same annotations to train the image processing model or a further image processing model.

8. A computer-implemented method for generating pairs of registered microscope images comprising:
training a generative model to create generated microscope images from input feature vectors comprising a plurality of feature variables,
wherein the training is carried out with at least two image data sets, which respectively contain microscope images of microscopic objects but which differ in an imaging/image property;
identifying which of the feature variables are object feature variables, which define at least object positions of microscopic objects in generated microscope images;
identifying which of the feature variables are imaging-property feature variables, which determine an appearance of the microscopic objects in generated microscope images as a function of the imaging/image property and which do not influence the object positions in generated microscope images;
generating at least one pair of registered microscope images, wherein each pair comprises a provided microscope image and a microscope image generated by the generative model, by:
back-projecting each provided microscope image into a feature space in order to ascertain values of object feature variables for the provided microscope image; and
creating an associated generated microscope image which is registered to the provided microscope image and which differs in an imaging/image property from the provided microscope image, by inputting a feature vector which has the values of the object feature variables ascertained by back-projection, but different values of the imaging-property feature variables, into the generative model.

9. The method according to claim 8,
wherein the imaging/image property relates to at least one of the following:
a contrast type of a microscopic measurement method or a chemical staining of a sample;
imaging parameters of an employed microscopy system, which relate in particular to an illumination or detection;
an employed microscopy system;
a resolution;
an image contrast;
a convolution by a point spread function underlying the microscope images;
a focal position;
a light scattering;
a light field measurement.

10. A method for providing an image processing model, comprising:
carrying out the method according to claim 8 for generating a plurality of pairs of registered microscope images which differ in an imaging/image property; and
using the plurality of pairs of registered microscope images as training data for an image processing model, wherein, for each of the pairs in the training, one of the microscope images is used as an input image and the other of the microscope images is used as a target image, so that the image processing model is trained to calculate, from an input microscope image, a processed microscope image which corresponds to a change in the imaging/image property vis-à-vis the input microscope image.

11. The method according to claim 10,
wherein the image processing model is trained to take an input microscope image and:
calculate a virtually stained image or a microscope image with a different contrast type, to which end the pairs of registered microscope images used in the training differ in the imaging/image property “contrast type”;
calculate an image of a higher resolution, to which end the pairs of registered microscope images used in the training differ in the imaging/image property “resolution”;
calculate a contrast-enhanced image, to which end the pairs of registered microscope images used in the training differ in the imaging/image property “image contrast”;
calculate an image deconvolution, to which end pairs of registered microscope images are used in the training which differ in the underlying convolution by a point spread function to which they correspond;
calculate an image with a changed focal position, to which end pairs of registered microscope images used in the training differ in the imaging/image property “focal position”;
perform a descattering calculation/a calculation to reduce a light scattering effect, to which end pairs of registered microscope images used in the training differ in the imaging/image property “light scattering”;
perform a light field measurement calculation, to which end pairs of registered microscope images are used in the training, one of which represents a result image of a light field measurement.

12. The method according to claim 8, further comprising:
generating a plurality of pairs of registered microscope images corresponding to different imaging parameter values;
providing annotations for the microscope images of one of the imaging parameter values, wherein the annotations are created manually, semi-automatically or automatically by a program;
transferring the annotations to the microscope images of the other of the imaging parameter values.

13. The method according to claim 12,
wherein the annotations indicate at least one of the following:
segmentation masks for the microscope images;
center points or boundaries of objects in microscope images;
classifications relating to a depicted sample, a depicted sample carrier or other depicted structures.

14. The method according to claim 12,
wherein the microscope images of one of the imaging parameter values are used together with the annotations to train an image processing model, and
wherein the microscope images of the other of the imaging parameter values are used together with the same annotations to train the image processing model or a further image processing model.

15. A microscopy system including:
a microscope for image acquisition; and
a computing device configured to carry out the computer-implemented method according to claim 1.

16. A non-transitory computer-readable medium comprising a computer program comprising commands which, when the program is executed by a computer, cause the computer to carry out the method according to claim 8.
